(19) United States
(12) Patent Application Publication
(10) Pub. No.: US 2008/0000363 A1
(43) Pub. Date: Jan. 3, 2008

(54) Adjustable Anti-Barring Device for Calender Rolls

(75) Inventor: Richard M. Strebel, Appleton, WI (US)

Correspondence Address: STIENNON & STIENNON, 612 W. MAIN ST., SUITE 201, P.O. BOX 1667, MADISON, WI, 53701-1667, US

(73) Assignee: METSO PAPER, INC., Helsinki (FI)

(21) Appl. No.: 11/457,950

(22) Filed: Jul. 17, 2006

Related U.S. Application Data
(63) Continuation-in-part of application No. 11/427,710, filed on Jun. 29, 2006, now abandoned.

(51) Int. Cl. B30B 3/04

(52) U.S. Cl. 100/169; 100/155 R

(57) ABSTRACT

A dynamic vibration absorber within a roll of a calender has a viscoelastic spring and damping element, which is compressed to adjust and control the spring constant and so the frequency response of the vibration absorber. The viscoelastic spring and damping element is compressed by a mechanical arrangement, or a hydraulic arrangement, which can be actuated exterior to the roll shell. One embodiment employs an adjustment rod, having left hand threaded portions and right hand threaded portions such that when the adjustment rod is rotated to cause two masses mounted interior to the roll shell to be drawn together compressing one or more viscoelastic spacers therebetween. A further embodiment adjustable dynamic vibration damper increases or decreases a secondary mass by adding or removing liquid from the interior of the secondary mass. This also has the effect of adjusting the characteristic frequency of the dynamic vibration absorber.

### CROSS REFERENCES TO RELATED APPLICATIONS

The present application is a continuation-in-part of U.S. application Ser. No. 11/427,710, filed Jun. 29, 2006, to Adjustable Anti-Barring Device for Calender Rolls, the disclosure of which is incorporated herein by reference.

### BACKGROUND OF THE INVENTION

The present invention relates to vibration control in a paper calender and more particularly to controlling vibration which leads to barring in a paper calender.

In a single or multi-nip calender, a phenomenon known as barring can occur. Barring manifests itself as of the development of axially extending distinctive and undesirable linear marks or impressions on the web. Where the rolls of the calender are all hard, i.e. metal, the effect of barring is usually limited to the paper web, with the rolls themselves being unaffected unless the barring is allowed to continue for an extended period of time. However, in the case of calender rolls having elastic or polymer roll covers, i.e. soft rolls, barring takes the form of the development of axially extending grooves and ridges on the cover of at least one soft roll, which in turn results in the paper web having a distinctive and undesirable linear barring impressed into the web. The barring effect becomes worse over time until the paper is no longer usable and the calender roll covers must be reworked or replaced.

Barring is thought to be the result of a pre-existing vibrational mode of the calender which is excited by a feedback loop, and which interacts with the viscoelastic web and/or viscoelastic roll covers. For example, the feedback may start with a very low amplitude vibration that causes a variation in pressure in a first nip of a calender. The variation in calender pressure creates a very small variation in web caliper. As the web moves through a subsequent calender nip these variations in web caliper are a source of excitation for the same pre-existing vibrational mode of the calender. This excited vibration mode causes the first calender nip to vibrate at a greater amplitude, thus impressing a greater caliper variation which in turn causes greater excitation of the pre-existing vibration mode as the web travels through the subsequent nip. Other feedback mechanisms may operate in single nip calenders. Over a longer or shorter period of time a calender elastic roll cover or even a hard roll surface can become grooved and the caliper variations in the paper web become more pronounced. Once the process of barring progresses to the stage where it is readily apparent, it can be difficult to correct, particularly in elastic or polymer roll covers. Turning down the calender roll covers may leave subtle density variations which will rapidly give rise to renewed barring.

One known approach to overcoming barring is to adjust or vary the distance the web travels between nips by offsetting nips in the roll stack to destroy the synchronization between subsequent nips. This approach, however, presents difficulties in supercalenders. Another approach is to vary the vibrational mode of one or more calender rolls by adding or subtracting mass by adding or removing a fluid such as water from the interior surface of the roll. A further approach is to add a dynamic vibration absorber to the interior of the roll. A dynamic vibration absorber is the combination of a secondary mass connected to a primary mass, e.g. a roll shell, by a spring and a damping element. Typically the spring and damping element are combined by the use of a viscoelastic material. By selection of the spring constant and the ratio between the primary mass and the secondary mass, the dynamic vibration absorber can be tuned to a problematic frequency, substantially dampening vibration at that frequency. Despite the existence of known solutions to the problem of barring, better approaches are desirable, particularly ones which could be used in all types of calenders and which incorporate simple adjustability to respond to the subtle nature of the barring phenomenon.

### SUMMARY OF THE INVENTION

The dynamic vibration absorber of this invention employs a viscoelastic spring and damping element, where variable compression of the viscoelastic material is used to control the spring constant and so tune the frequency response of the vibration absorber. The compression of the viscoelastic material situated between the primary mass, i.e., the roll shell, and the secondary mass positioned interior to the roll shell is compressed by means of a mechanical or hydraulic arrangement, which can be actuated exterior to the roll shell. One embodiment employs an adjustment rod, having left hand threaded portions and right hand threaded portions such that when the adjustment rod is rotated to cause two masses mounted interior to the roll shell to be drawn together compressing one or more viscoelastic spacers therebetween. In another embodiment a single tapered mass is mounted to a roll shell by a wedge of viscoelastic material forming a circumferential tapered plug. The tapered mass is drawn by an adjustment rod toward one end of the roll shell to compress the viscoelastic material, thereby varying its spring constant.

An alternative arrangement for varying the spring constant in the dynamic vibration absorber of this invention employs a hydraulic or pneumatic actuator situated either interior or exterior to the roll shell and arranged to supply compressive force to the viscoelastic material to thus control the spring constant and thus the frequency response of the dynamic vibration damper. Using a hydraulic actuator facilitates adjusting the spring constant while the calender is in operation by transmitting hydraulic pressure through a rotating pneumatic or hydraulic union.

A further embodiment adjustable dynamic vibration damper increases or decreases the secondary mass by adding or removing liquid from the interior of the secondary mass. This also has the effect of adjusting the characteristic frequency of the dynamic vibration absorber.

It is a feature of the present invention to provide an apparatus and method for actively preventing barring in a paper or board calender.

It is a further feature to the present invention to provide a calender roll with an internally mounted dynamic vibration absorber which can be adjusted from the exterior of the roll.

It is another feature of the present invention to provide a calender roll with an internally mounted vibration absorber wherein the spring constant can be adjusted.

It is yet another feature of the present invention to provide a calender roll with an internally mounted vibration absorber in which the secondary mass can be adjusted.

Further features and advantages of the invention will be apparent from the following detailed description when taken in conjunction with the accompanying drawings.

### BRIEF DESCRIPTION OF THE DRAWINGS

FIG. 1 is a partial side elevational cross-sectional view of the calender roll incorporating the dynamic vibration damper of this invention.

FIG. 2 is a partial side elevational cross-sectional view of an alternative embodiment of the dynamic vibration damper of this invention.

FIG. 3 is a partial side elevational cross-sectional view of a further alternative embodiment of the dynamic vibration damper of this invention.

FIG. 4 is a partial side elevational cross-sectional view of a yet further embodiment of the dynamic vibration damper of this invention.

FIG. 5 is a partial side elevational cross-sectional view of a still further alternative embodiment of the dynamic vibration damper of this invention.

FIG. 6 is a partial side elevational cross-sectional view of yet another alternative embodiment of the dynamic vibration damper of this invention.

FIG. 7 is a side elevational view of an supercalender with rolls employing the dynamic vibration damper of this invention.

FIG. 8 is a partial side elevational cross-sectional view of another yet further alternative embodiment of the dynamic vibration damper of this invention.

### DESCRIPTION OF THE PREFERRED EMBODIMENTS

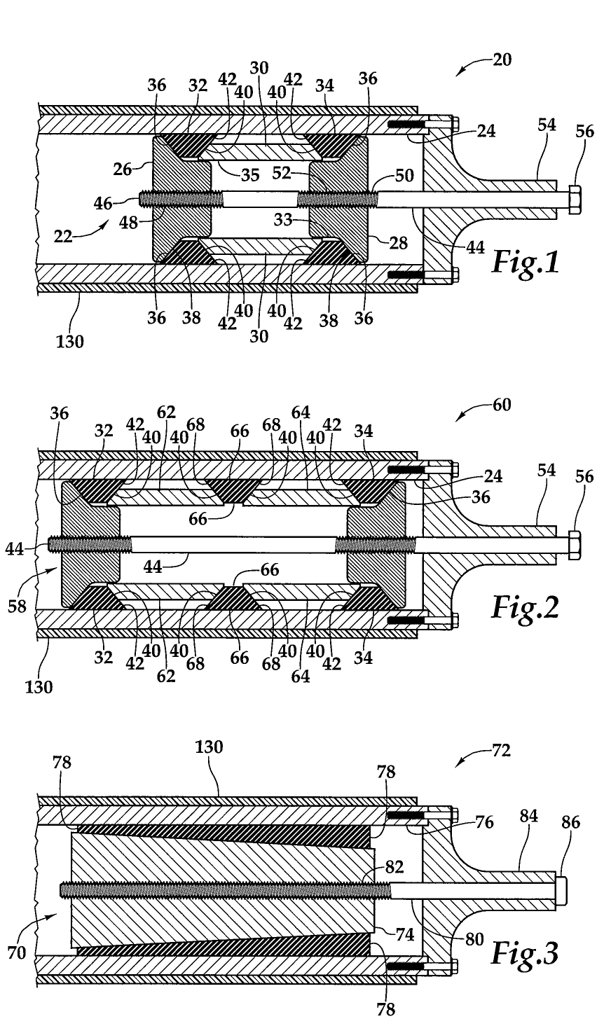

Referring more particularly to FIGS. 1-8 wherein like numbers refer to similar parts, a calender roll 20 which contains a dynamic vibration damper 22 is shown in FIG. 1. The damper 22 is comprised of a primary mass i.e., a roll shell 24, and three secondary masses: a first hat shaped mass 26, a second hat shaped mass 28, a spacer tube mass 30, and a first viscoelastic ring 32 and a second viscoelastic ring 34. The hat shaped masses 26, 28 have tapered flanges 36 which bear against tapered outer sides 38 of the viscoelastic rings 32 and 34. The spacer tube 30 is positioned between the viscoelastic rings 32, 34 and has conical end surfaces 40 which bear on tapered inner sides 42 of the viscoelastic rings 32 and 34. An adjustment rod 44 has a right hand threaded portion 46 which is threadedly engaged with a threaded hole 48 in the first hat shaped mass 26. The adjustment rod 44 has a left-hand threaded portion 50 which is threadedly engaged with a threaded hole 52 in the secondary hat shaped mass 28. The adjustment rod 44 extends to the exterior of the roll through the roll end bearing 54. The adjustment rod 44 terminates with a bolt head 56 which can be rotated to draw the secondary masses 26, 30, and 28 together, thus compressing the first and second viscoelastic rings 32, 34 between the hat shaped masses 26, 28, the spacer tube 30 and the roll shell 24, thereby changing the first and second viscoelastic rings' spring constant. By changing the spring constant the characteristic frequency of the dynamic vibration damper 22 is adjusted in a predictable way. The hat shaped masses 26, 28 have cylindrical portions 33 which engage the inside cylindrical surface is of the spacer tube 30 which function to guide the movements of the hat shaped masses 26, 28 as they are drawn together by rotation of the adjustment rod 44.

Barring is normally first detected by monitoring roll vibration and detecting a heightened amplitude of a particular frequency which indicates vibration at that particular frequency is of concern. Generally the frequency of concern is between 40 and 1000 Hz. If early action is taken to increase damping at that frequency, barring of the roll surfaces, and therefore of the paper, can be avoided. Normally the dynamic vibration damper 22 will be designed to dampen vibration at known characteristic frequencies between 40 and 1000 Hz of the calender roll or of a calender in which the roll is installed. Normally a dynamic vibration damper 22 will be installed on each end of the roll of FIG. 1 such that the other end of the roll (not shown) will be a mirror image of the end shown. After installation of the dynamic vibration damper 22 the frequency of the damper can be adjusted based on actual machine running conditions to optimize the damping characteristics of the dynamic vibration damper 22. Further continual monitoring of vibration in the calender in which the roll is installed can be employed to determine if the roll is exhibiting an increase in a vibration at a particular frequency. If vibration at the particular frequency is increasing in amplitude over time the dynamic vibration damper 22 can be adjusted to increase the damping at the identified frequency.

An alternative embodiment dynamic vibration damper 58 installed in a roll 60 is shown in FIG. 2. The dynamic vibration damper 58 extends the damping action over a greater proportion of the roll 60. The dynamic vibration damper 58 is substantially similar to the dynamic vibration damper 22 except that a first spacer tube 62 and a second spacer tube 64 replace the single spacer tube mass 30 shown in FIG. 1. A third viscoelastic ring 66 is positioned between the first and second spacer tubes 62, 64. The third viscoelastic ring 66 has tapered sides 68 which engage conical end surfaces 40 of the spacer tube 62, 64. Rotating the bolt head 56 will again cause the adjustment rod 44 to rotate in and will compress the viscoelastic rings 32, 66, 34 changing the spring constant of the dynamic vibration damper 58. The roll 60 will normally employ at least two dynamic vibration dampers 58 arranged symmetrically at each end as mirror images.

A further alternative embodiment dynamic vibration damper 70 installed in a roll 72 is shown in FIG. 3. The dynamic vibration damper 70 can readily be arranged to distributed the masses and the damping action over the length of the roll 72. The dynamic vibration damper 70 has a single frustroconical secondary mass 74 connected to the primary mass represented by the shell 76 of the roll 72 by a cylindrical/conical viscoelastic shell 78, within an interior taper of the conical shell corresponding to but opposite to the taper of the frustroconical secondary mass 74. The viscoelastic shell 78 functions as the spring and damper of the simple dynamic vibration damper 70. A simple adjustment rod 80 with a single thread 82 draws the mass toward the roll end bearing 84 when the bolt head 86 is rotated. Rotation of the rod 80 thereby compresses the viscoelastic shell 78 to change the spring constant of the dynamic vibration damper 70.

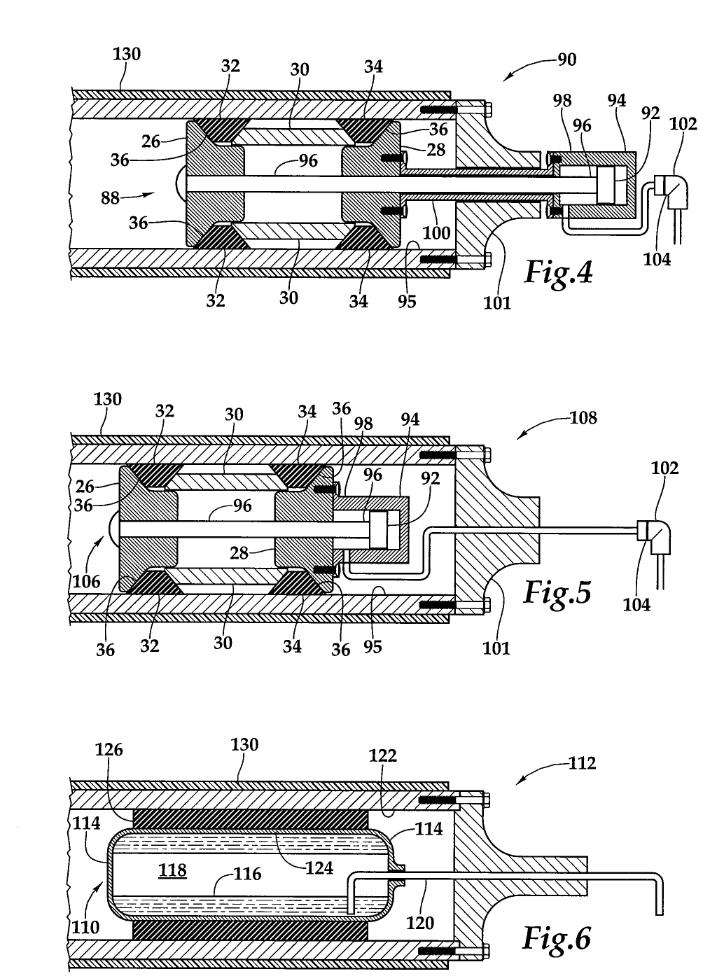

A yet further alternative embodiment dynamic vibration damper 88 installed in a roll 90 is shown in FIG. 4. The arrangement of the dynamic vibration damper 88 illustrated in FIG. 4 is basically identical to the dynamic vibration damper 22 illustrated in FIG. 1 except that instead of a left and right handed threaded adjustment rod 44, a pneumatic or hydraulic piston 92 in an actuator 94, located outside the cylindrical roll shell 95, is used to draw on a piston rod 96. The piston rod 96 extends through the end bearing 101 and the second hat shaped mass 28 and is connected to apply a tension to the first hat shaped mass 26. The housing 98 of the actuator 94 presses on a shaft 100 which extends through the roll end bearing 101 and engages the second hat shaped mass 28 pushing it against the second viscoelastic ring 34. Hydraulic or pneumatic pressure to the actuator 94 can be supplied through a rotating pneumatic-hydraulic union 102 such as can be obtained from Deublin Company, Waukegan, Ill. The pneumatic-hydraulic union 102 employs a rotating seal 104. The supply of pneumatic-hydraulic fluid through the rotating seal 104 allows control of the compression of the viscoelastic rings 32, 34 even while the calender is operating.

A still further alternative embodiment dynamic vibration damper 106 installed in a roll 108 is illustrated in FIG. 5. The arrangement illustrated in FIG. 5 is similar to that shown in FIG. 4 except the pneumatic or hydraulic actuator 94 is mounted interior to the shell 95 of the roll. In FIG. 5 the actuator housing 98 is directly fixedly mounted to the second hat shaped mass 28. A piston rod 96, shorter but otherwise substantially similar to the arrangement illustrated in FIG. 4, connects to the first mass 26. Again the use of the pneumatic or hydraulic actuator 94 is combined with a union 102 with a rotating seal 104.

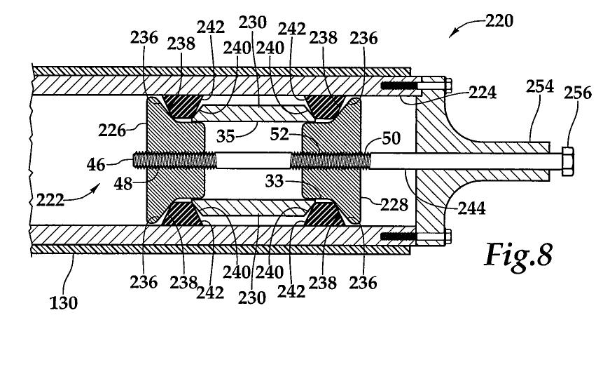

Another yet further alternative embodiment dynamic vibration damper 222 installed in a roll 220 is illustrated in FIG. 8. The arrangement illustrated in FIG. 8 is similar to that shown in FIG. 1. The damper 222 is comprised of a primary mass, i.e., a roll shell 224, and three secondary masses: a first hat shaped mass 226, a second hat shaped mass 228, a spacer tube mass 230, and a first viscoelastic ring 232 and a second viscoelastic ring 234. The dynamic vibration damper 222 differs from the damper 222 in that the hat shaped masses 226, 228 have tapered flanges 236 which have tapers which are different and more gradual than the tapered outer sides 238 of the viscoelastic rings 232 and 234. Further, the spacer tube 230 which is positioned between the viscoelastic rings 232, 234 has conical end surfaces 240 which are different and more gradual than the tapered inner sides 242 of the viscoelastic rings 232 and 234. The result of the mismatch in tapers between the tapered flanges 236, and the conical end surfaces 240 of the spacer tube 230 and the tapered surfaces 238, 242 of the viscoelastic rings 232, 234 is to make the spring constant of the dynamic vibration damper 222 more sensitive to compression caused by rotation of the adjustment rod 244. The spring constant is more sensitive to compression due to the mismatch of the engagement surfaces between the viscoelastic rings 232, 234 in the secondary masses 226, 228, and 230 because with compression the contact area increases as compression increases. A greater change in spring constant means a greater ability to adjust the damping frequency of the vibration damper 222.

Yet another alternative embodiment dynamic vibration damper 110 installed in a roll 112 is illustrated in FIG. 6. A dynamic vibration damper has three basic parts: a primary mass, a secondary mass, and a spring with a selected spring constant. A fourth element, a damping element, adds damping to the system. In the systems illustrated in FIGS. 1-5 the response of the dynamic vibration damper is adjusted by compressing one or more viscoelastic components to thereby change the spring constant. The embodiment shown in FIG. 6, instead of varying the spring constant, varies the magnitude of the secondary mass 114. Variation of the secondary mass is accomplished by adding or removing a liquid 116 to an interior volume 118 formed within the secondary mass 114. The liquid can be added and removed through a siphon 120 similar to the siphon commonly used to remove condensation from the interior of steam heated dryer rolls. The liquid 116, due to the centrifugal force caused by the rotation of the roll shell 122, becomes evenly distributed about a cylindrical surface 124 formed by the secondary mass 114. The secondary mass 114 is connected and positioned within the roll shell 122 by a viscoelastic cylindrical shell 126 which forms the spring and damping element of the dynamic vibration damper 110.

The addition of mass in the form of liquid to the interior of the secondary mass 114 actually has two effects, that of adjusting the damping frequency of the dynamic vibration damper 110, and that of changing the fundamental frequencies of the entire roll 112 by increasing the roll mass.

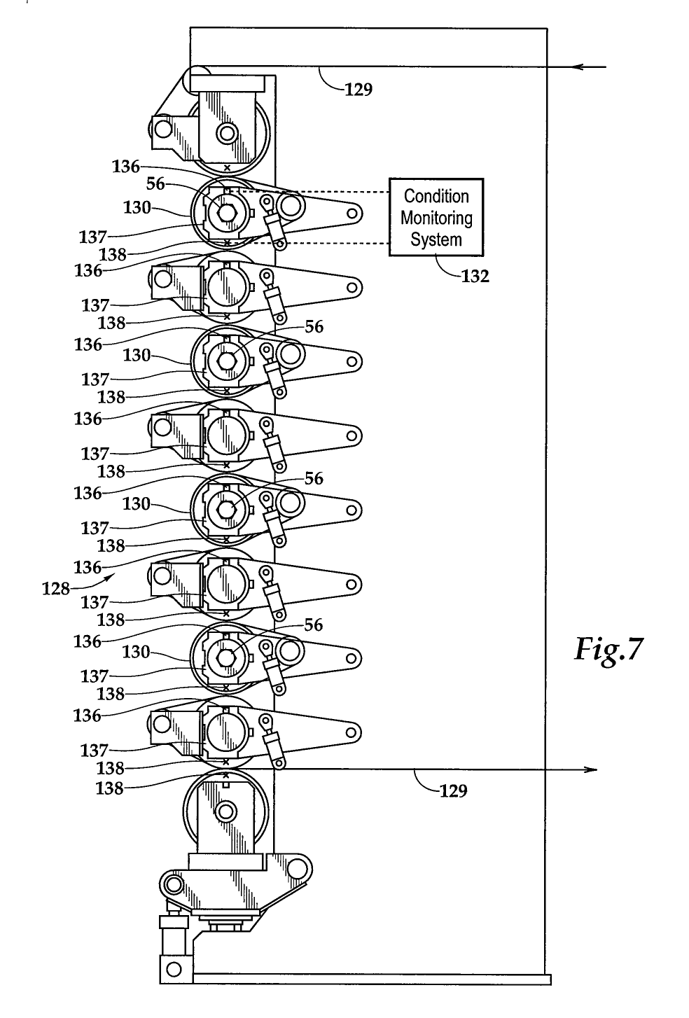

The rolls 20, 60, 72, 90, 108, 112 will typically be, for example, one or more rolls in a supercalender 128 for calendering a paper or board web 129 shown in FIG. 7. The roll with adjustable dynamic vibration dampers will typically be resilient rolls having a polymer i.e., elastomer cover 130 as illustrated in FIGS. 1-6 to more closely position the vibration damping close to the problematic structure, e.g., the elastomeric cover 130 which is subject to barring due to undesired vibration. Corrugation of the viscoelastic roll covers 130 is the ultimate source and result of the barring phenomena.

It should be understood that the various dynamic vibration dampers can be adjusted without removal of the roll shell bearing ends and without removing the rolls from the calender. Further, the hydraulic arrangement of FIG. 4-5 and the siphon mass additions shown in FIG. 6 can be adjusted while the calender is operating. The adjustment means shown in FIG. 1-3 are readily adjusted when the calender is stopped but it should be understood that an electric or pneumatic or hydraulic adjustment mechanism to turn the bolt head 56, 86 could be mounted to rotate with the rolls and supplied with electricity or hydraulic or pneumatic fluid through a commutator or a rotating seal.

Barring in a calender such as the supercalender 128 can be monitored by a Condition Monitoring System 132 wherein the front side and the back side of each roll 130 in the calender are monitored by vibration sensors 136. The vibration sensors 136 may be two or three axis accelerometers 136 mounted on the front side and the back side roll bearings 137. Each roll 130 will also be equipped with a magnetic trigger 138 that measures the roll's rotation speed. The outputs of these sensors 136, 138 are used to perform an analysis known as Synchronous Time Averaging, or STA. Such systems are available from Metso Automation Helsinki Finland under the trade name Sensodec 6S.

If a roll is corrugated or out-of-round, so as to cause barring, it creates vibrations in adjacent rolls and the vibration is then transmitted throughout the entire calender. STA analyses are performed simultaneously on each roll to determine which roll is the source of the vibration problem. STA analysis uses the magnetic rotation sensor as a trigger to collect numerous signal periods which are then averaged for each roll. The remaining signal, after averaging, and its frequency characteristics are identified to a particular roll. In this way a roll causing vibration can be positively identified along with the problem frequency. The fast update times of these analyses allows for a fast reaction to potential roll damage. Synchronous Time Averaging analysis can be used with the dynamic vibration damper 22, 58, 70, 88, 106 or 110 which allow the damping characteristics of the dynamic vibration damper to be adjusted by adjusting the spring constant of the viscoelastic members 32, 34, 66, 78, or by adding mass to the secondary mass 114. The damping characteristics of the dynamic vibration dampers can be adjusted during calender operations based on the known problem frequency to increase damping at the problem frequency. Time-based trends which show the vibration history of a certain roll based on the STA analyses can be used to monitor the effectiveness of adjustments made to the dynamic vibration dampers.

It should be understood that every roll in a calender or supercalender may be instrumented with sensors to detect vibration and rotation, and every roll may have a dynamic vibration damper internal to the roll shell which can be adjusted externally while the calender is in operation.

It should be understood that the viscoelastic elements 32, 34, 66, 78, can be arranged by means of various geometries to change engagement or shape so that compression of the viscoelastic elements produces maximum variability in the spring constant and thus increases the adjustability of the characteristic damping frequency of the dynamic vibration damper. Such geometries include a crowned or curved surface on the viscoelastic member or on a surface compressing the viscoelastic member. Generally it is possible to include any dissimilar contact shape between the viscoelastic member and a surface on the secondary masses, which give a greater change in spring rate and thus greater resultant change in damping frequency for a given change in contact loading.

It is understood that the invention is not limited to the particular construction and arrangement of parts herein illustrated and described, but embraces all such modified forms thereof as come within the scope of the following claims.

1. A calender roll with an adjustable dynamic damper, comprising:
a roll shell forming a primary mass, and defining a roll interior;
a secondary mass positioned within the roll interior;
at least one viscoelastic element positioned between the roll shell and the secondary mass; and
a variable actuator arranged to vary compression of the at least one viscoelastic element between the secondary mass and the roll shell.

2. The calender roll of claim 1 wherein the secondary mass has a first surface which engages a second surface of the at least one viscoelastic element to define a contact area where the first surface meets the second surface, and wherein the first surface and the second surface are chosen so that the contact area varies as the compression of the at least one viscoelastic element between the secondary mass and the roll shell varies.

3. The calender roll of claim 1 wherein the at least one viscoelastic element is arranged so that it changes engagement or shape when compressed so as to increase variability in a spring constant defined by the at least one viscoelastic element.

4. The calender roll of claim 1 wherein the roll shell has an exterior and a roll end bearing, and wherein the variable actuator has portions which extend through the roll end bearing to allow controlling compression of the viscoelastic element exterior to the roll shell.

5. The calender roll of claim 3 wherein the variable actuator further comprises an adjustment rod extending through the roll end bearing, the adjustment rod threadedly engaging the secondary mass, to cause movement of the secondary mass with respect to the primary mass when the adjustment rod is rotated.

6. The calender roll of claim 5, wherein the secondary mass is further comprised of a first mass and a second mass, and wherein the adjustment rod has right hand thread portions which are threadedly engaged with the first mass and left-hand threaded portions which are threadedly engaged with the second mass left hand threaded portions, wherein rotation of the adjustment rod moves the first mass and the second mass together, thereby compressing the at least one viscoelastic element.

7. The calender roll of claim 6, further comprising a first viscoelastic element, a second viscoelastic element, and a third secondary mass positioned between the first and second secondary masses such that motion of the first and second secondary masses towards each other compresses the first viscoelastic element between the first secondary mass and the third secondary mass, and compresses a second viscoelastic element between the second secondary mass and the third secondary mass.

8. The calender roll of claim 7, wherein the third secondary mass is comprised of two parts with a third viscoelastic element therebetween.

9. The calender roll of claim 1 wherein the variable actuator is a hydraulic or pneumatic actuator situated interior to the roll shell and arranged to supply compressive force to the at least one viscoelastic element to thus control the spring constant and thus the frequency response of the dynamic vibration damper.

10. The calender roll of claim 9 wherein the roll shell has an exterior and a roll end bearing, and wherein the variable actuator has portions which extend through the roll end bearing to allow controlling compression of the at least one viscoelastic element exterior to the roll shell.

11. The calender roll of claim 10 further comprising a pneumatic or hydraulic union having a rotating joint mounted to the roll end bearing for transmitting hydraulic or pneumatic pressure to the roll as it rotates.

12. The calender roll of claim 1 wherein the roll shell has an exterior and a roll end bearing, and wherein the variable actuator is a hydraulic or pneumatic actuator mounted to the roll end bearing having portions which extend through the roll end bearing to allow controlling compression of the at least one viscoelastic element interior to the roll shell.

13. The calender roll of claim 1 wherein the roll shell is covered with an elastomeric cover.

14. A calender for a paper or board web with a mechanism to prevent barring, comprising:
a first roll of the calender,
a second roll having a roll shell and a viscoelastic cover, the second roll defining a roll interior, the second roll forming a nip with the first roll;
an adjustable viscoelastic dynamic damper formed in the interior of the second roll, wherein the roll shell forms a primary mass of the viscoelastic dynamic damper;
a secondary mass positioned within the roll interior;
at least one viscoelastic element positioned between the roll shell and the secondary mass, the at least one viscoelastic element defining a spring constant; and
a variable actuator arranged to vary the spring constant of the at least one viscoelastic element between the secondary mass and the roll shell.

15. The calender of claim 14 wherein the secondary mass has a first surface which engages a second surface of the at least one viscoelastic element to define a contact area where the first surface meets the second surface, and wherein the first surface and the second surface are chosen so that the contact area varies as the compression of the at least one viscoelastic element between the secondary mass and the roll shell varies.

16. The calender of claim 14 wherein the at least one viscoelastic element is arranged so that it changes engagement or shape when compressed so as to increase variability in a spring constant defined by the at least one viscoelastic element.

17. The calender of claim 14 wherein the roll shell has an exterior and roll end bearing, and wherein the variable actuator has portions which extend through the roll end bearing to allow controlling the spring constant of the at least one viscoelastic element exterior to the roll shell.

18. The calender of claim 15 wherein variable actuator further comprises an adjustment rod extending through the roll bearing end, the adjustment rod threadedly engaging the secondary mass, to cause movement of the secondary mass with respect to the primary mass when the adjustment rod is rotated.

19. The calender of claim 16, wherein the secondary mass is further comprised of a first mass and a second mass, and wherein the adjustment rod has right hand thread portions which are threadedly engaged with the first mass and left-hand treaded portions which are threadedly engaged with the second mass left hand threaded portions wherein rotation of the adjustment rod moves the first mass and the second mass together there by changing the spring constant of the at least one viscoelastic element.

20. The calender of claim 19, further comprising a first viscoelastic element, and a second viscoelastic element and a third secondary mass positioned between the first and second secondary mass such that motion of the first and second secondary masses towards each other changing the spring constant of the first viscoelastic element between the first secondary mass and the third secondary mass, and changes the spring constant of a second viscoelastic element between the second secondary mass and the third secondary mass.

21. The calender of claim 20, wherein the third second mass is comprised of two parts with a third viscoelastic element therebetween.

22. The calender of claim 14 wherein the variable actuator is a hydraulic or pneumatic actuator situated interior to the roll shell and arranged to supply a changing load on the at least one viscoelastic element to thus control the spring constant and thus the frequency response of the dynamic vibration damper.

23. The calender of claim 22 wherein the roll shell has a exterior and a roll end bearing, and wherein the variable actuator has portions which extend through the roll end bearing to allow controlling the spring constant of the at least one viscoelastic element exterior to the roll shell.

24. The calender of claim 23 further comprising a pneumatic or hydraulic union having a rotating joint mounted to the roll end for transmitting hydraulic or pneumatic pressure to the roll as it rotates.

25. The calender of claim 14 wherein the roll shell has an exterior and a roll end bearing, and wherein the variable actuator is a hydraulic or pneumatic actuator mounted to the roll end bearing having portions which extend through the roll end bearing to allow controlling the spring constant of the at least one viscoelastic element interior to the roll shell.

26. A calender roll with an adjustable dynamic damper, comprising:
a roll shell forming a primary mass, and defining a roll interior, a roll exterior and a roll end bearing;
a secondary mass positioned within the roll interior, the secondary mass having portions defining an interior volume;
at least one viscoelastic element positioned between the roll shell and the secondary mass; and
a siphon extending from the roll exterior through the roll end bearing into the interior volume defined by portions of the secondary mass, the siphon having a passageway such that fluid can be exchanged between the interior volume and the exterior of the roll.

27. A method of actively preventing barring in a calender comprising the steps of:
monitoring the vibration of individual rolls of a multiroll calender with individual sensors mounted on each roll bearing housing;
simultaneously sensing each calender roll's angular position and performing synchronous time averaging analysis for each roll;
from the synchronous time averaging analysis for each roll determining at least one roll responsible for exciting a vibration frequency, and determining the frequency of the excited vibration frequency; and
while the calender is operating adjusting a spring constant, or secondary mass of a dynamic vibration damper within a roll shell of the at least one roll, so as to increase the damping by the dynamic vibration damper of the excited vibration frequency.

28. A method of actively preventing barring in a calender comprising the steps of:
determining in a multi-roll calender at least one roll responsible for exciting a vibration frequency, and determining the frequency of the excited vibration frequency;
while the calender is operating adjusting a spring constant or secondary mass of a dynamic vibration damper within a roll shell of the at least one roll, so as to increase the damping by the dynamic vibration damper of the excited vibration frequency.
